(19) United States
(12) Patent Application Publication
(10) Pub. No.: US 2026/0092479 A1
(43) Pub. Date: Apr. 2, 2026

(54) Bearing Device

(71) Applicant: ENROAD CO.,LTD, Jiangsu (CN)

(72) Inventors: Haiming TAN, Jiangsu (CN); Xiuzhi YU, Jiangsu (CN); Guangshan WANG, Jiangsu (CN)

(73) Assignee: ENROAD CO.,LTD, Jiangsu (CN)

(21) Appl. No.: 19/314,746

(22) Filed: Aug. 29, 2025

(30) Foreign Application Priority Data
Sep. 27, 2024 (CN) 202411357354.1

(51) Int. Cl. E05C 3/16; B60R 9/055

(52) U.S. Cl. CPC E05C 3/16; B60R 9/055

(57) ABSTRACT

The present disclosure relates to a bearing device, pertaining to the technical field of vehicle accessories. The bearing device further comprises a box body, a box lid, a fixed locking element, a movable locking element and an unlocking device. The movable locking element can be engaged with the fixed locking element in a locked state, with one of them installed on the box body and the other on the box lid. The movable locking element is also equipped with a movably matched linkage component and a driving component.

### CROSS-REFERENCE TO RELATED APPLICATIONS

This application claims priority to Chinese Patent Application No. 202411357354.1, filed on Sep. 27, 2024, the content of which is incorporated herein by reference in its entirety.

### TECHNICAL FIELD

The present disclosure relates to the technical field of vehicle accessories, particularly to a bearing device.

### BACKGROUND

Storage boxes installed on car roofs, also known as roof boxes, serve as devices to expand vehicle cargo space and are widely used in scenarios such as outdoor travel and long-distance road trips. Roof boxes are typically made of sturdy materials, effectively protecting stored items like luggage, sports equipment, and camping gear from external environmental impacts such as wind, rain, and dust.

Roof boxes are generally secured through clamps mounted on roof rails or racks, a design that facilitates relatively easy installation and removal while providing sufficient stability and safety to ensure no adverse effects on driving safety during vehicle operation. With the increasing popularity of roof boxes, their safety concerns have become more prominent. To offer additional security and anti-theft functionality, existing roof boxes are usually equipped with locking mechanisms to secure the lid, preventing unauthorized access to the box and its contents.

However, the relatively simple structure of current locking mechanisms allows others to quickly unlock them. Once the unlocking tool or method is obtained, the roof box can be opened in a short time, leading to theft of the contents and posing certain safety risks.

### SUMMARY

The present disclosure provides a bearing device to address the issues raised in the background art.

A bearing device comprises a box body and a box lid that are openable and closable, and further comprising: a fixed locking element; a movable locking element, capable of locking into and engaging with the fixed locking element, wherein one of the movable locking element and the fixed locking element is installed on the box body and the other on the box lid, and the movable locking element is movably switchable between a locked state and an unlocked state; and an unlocking device installed on the box body or the box lid, wherein the unlocking device is equipped with a toggling block assembly that drives the movable locking element to move, and at least one unlocking module for releasing the toggling block assembly.

A bearing device comprises a box body and a box lid that are openable and closable; and a fixed locking element and a movable locking element, wherein one of the fixed locking element and the movable locking element is arranged on the box body and the other on the box lid, with the movable locking element capable of locking into and engaging with the fixed locking element, wherein the movable locking element comprises a linkage component and a driving component that are movably engaged, the linkage component is configured to reciprocate along a first direction, and the driving component is configured to reciprocate along a second direction, such that when the linkage component moves along the first direction, the driving component moves along a direction different from the first direction, enabling the movable locking element to switch between a locked state and an unlocked state; and an unlocking device configured to provide an operating position for a user on the box body or the box lid, wherein the unlocking device comprises a toggling block assembly capable of driving the movable locking element to move, a first unlocking module, and a second unlocking module, and the first unlocking module and/or the second unlocking module is configured to lock and release the toggling block assembly.

To achieve the above objectives, the present disclosure adopts the following technical solutions:

The movable locking element employs a bidirectional motion coupling structure of the linkage component and the driving component, making it impossible for intruders to directly unlock it by applying force in a single direction or using simple tools. For example, traditional lock cores only require rotation to unlock, whereas this solution necessitates first pushing the linkage component along the first direction to release the transverse lock, followed by the driving component completing the longitudinal unlock along the second direction. The complexity of the motion trajectory increases the difficulty of illegal unlocking operations, effectively delaying the intrusion process. Meanwhile, in scenarios of vehicle jolts or vibrations, the bidirectional motion constraints of the linkage component and the driving component can automatically compensate for deformation gaps, preventing accidental unlocking due to resonance and effectively avoiding unintended opening of the box lid, thereby enhancing the operational safety of the bearing device under complex road conditions.

By implementing a combined locking mechanism of the first unlocking module and the second unlocking module, dual control over the toggling block assembly is achieved. Traditional single-module unlocking devices can be directly opened once compromised, whereas this solution ensures that even if one module is illegally breached, the other can still prevent the unlocking action, fundamentally eliminating risks of brute-force attacks or technical lock-picking, thereby enhancing the anti-theft performance of the bearing device.

### BRIEF DESCRIPTION OF DRAWINGS

The drawings, which form a part of this application, are provided to further illustrate the present disclosure. The illustrative embodiments and descriptions of the present disclosure are intended to explain the present disclosure and do not constitute an undue limitation thereof. In the drawings:

FIG. 1 is a perspective schematic diagram of an embodiment provided by the present disclosure;

FIG. 2 is a schematic diagram showing the cooperation of the fixed locking element, the movable locking element and the unlocking device in an embodiment provided by the present disclosure;

FIG. 3 is an exploded schematic diagram of the fixed locking element, the movable locking element and the unlocking device in an embodiment provided by the present disclosure.

FIG. 4 is a schematic diagram of the structure of the movable locking element in an embodiment provided by the present disclosure.

FIG. 5 is the first exploded view of the movable locking element in an embodiment provided by the present disclosure.

FIG. 6 is the second exploded view of the movable locking element in an embodiment provided by the present disclosure.

FIG. 7 is the first schematic diagram of the internal structure of the movable locking element in an embodiment provided by the present disclosure.

FIG. 8 is the second schematic diagram of the internal structure of the movable locking element in an embodiment provided by the present disclosure.

FIG. 9 is a schematic diagram of the locked state structure of the latching hook assembly in an embodiment provided by the present disclosure.

FIG. 10 is a schematic diagram of the unlocked state structure of the latching hook assembly in an embodiment provided by the present disclosure.

FIG. 11 is the first schematic diagram of the unlocking device structure in an embodiment provided by the present disclosure (the movable locking element is in the locked state).

FIG. 12 is the second schematic diagram of the unlocking device structure in an embodiment provided by the present disclosure (the movable locking element is in the unlocked state).

FIG. 13 is the third schematic diagram of the unlocking device structure in an embodiment provided by the present disclosure.

FIG. 14 is an exploded view of the unlocking device in an embodiment provided by the present disclosure.

Reference signs: Fixed locking element (10); Pressure rod (11); Movable locking element (20); Linkage component (21); Mounting hole (211); Compressing part (212); Guiding inclined surface (213); Driving component (22); Conforming inclined surface (221); Oblong hole (222); Latching hook assembly (23); Hook base (231); Hook groove (2311); First latching hook (232); Second latching hook (233); Engagement hook (2331); Lift-off hook (2332); Fool-proofing component (24); First elastic component (25); Assembly housing (26); Second elastic component (27); Unlocking device (30); Toggling block assembly (31); First unlocking module (32); Second unlocking module (33); Connecting rod (34); Dead stroke section (341); Mounting case (35); Warning strip (36); Box body (40); Box lid (50).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

The storage box installed on the roof of a car, also known as a roof box, is a practical device specifically designed to expand the vehicle's storage capacity. Mounted on the roof rack, it provides additional storage space for self-driving trips, outdoor adventures, or family travel, thereby freeing up interior space and avoiding the impact of luggage clutter on ride comfort. It is widely used in scenarios such as outdoor travel and long-distance self-driving.

Roof boxes are typically made of sturdy materials, offering impact resistance and scratch protection. Additionally, when equipped with sealing strips, they can achieve rain and dust resistance, protecting the contents inside from moisture, dust, or sun damage.

As known from the background technology, roof boxes are generally secured through clamps installed on roof rails or racks. This design makes the installation and removal of the roof box relatively convenient while providing sufficient stability and safety, ensuring no negative impact on driving safety during vehicle operation. With the increasing popularity of roof boxes, their security issues have become more prominent. To offer additional safety and anti-theft functionality, existing roof boxes are typically equipped with locking mechanisms to secure the box lid, preventing unauthorized individuals from opening the box and removing its contents.

However, the structure of existing locking mechanisms is relatively simple, allowing others to quickly unlock them. Once the unlocking tool or method is obtained, the roof box can be opened in a short time, leading to theft of internal items and posing certain security risks for the roof box.

In view of this, this embodiment provides a bearing device. The movable locking element of this bearing device adopts a non-linear linkage design, increasing the difficulty of tampering. Meanwhile, the unlocking device achieves dual anti-theft protection by incorporating a first unlocking module and a second unlocking module, thereby addressing the security risks caused by the simplistic structure of the locking mechanism in related products.

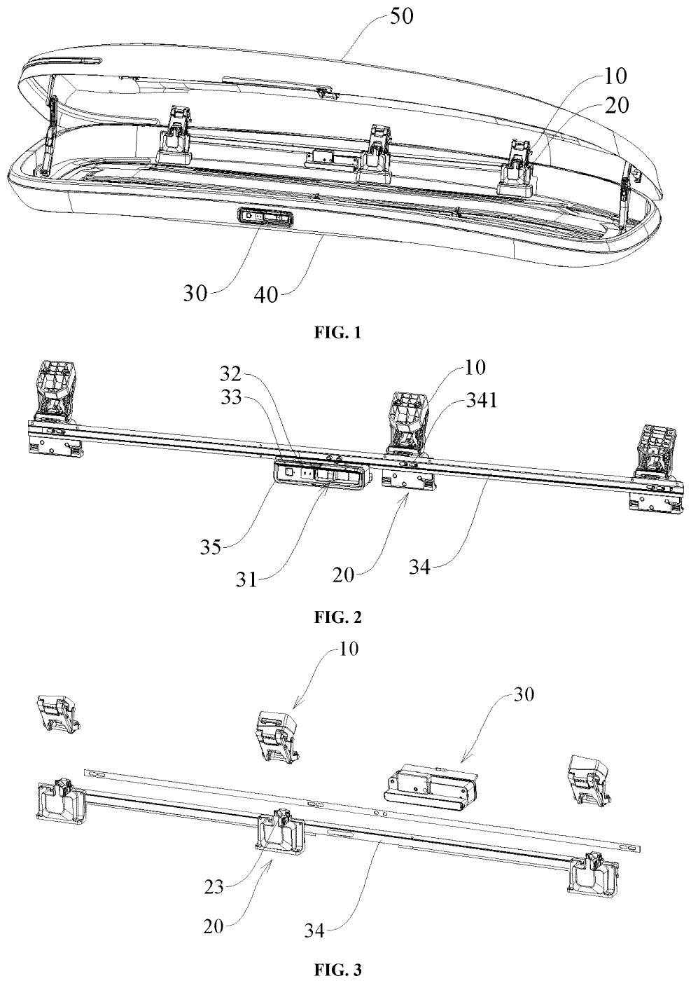

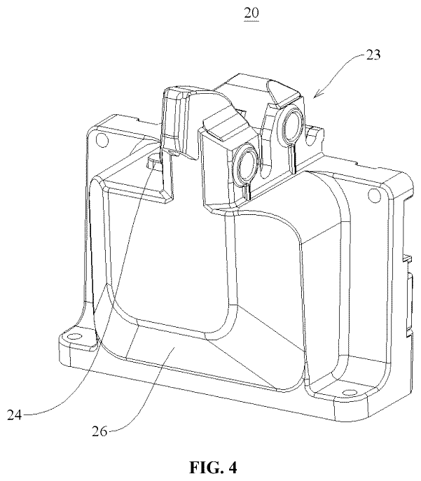

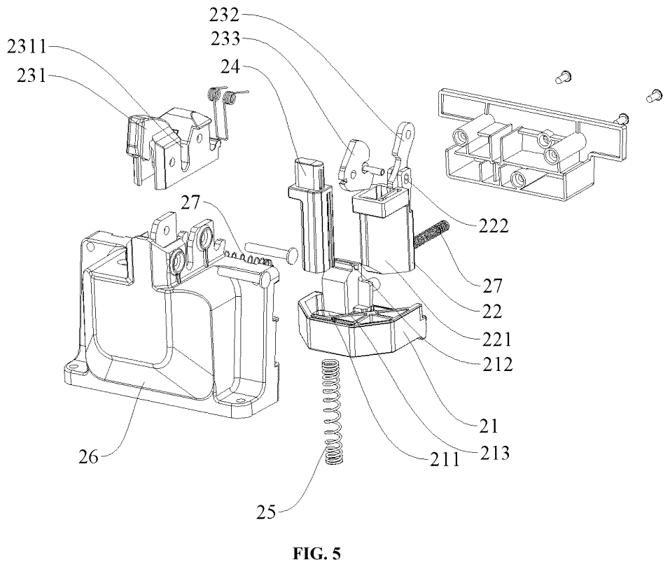

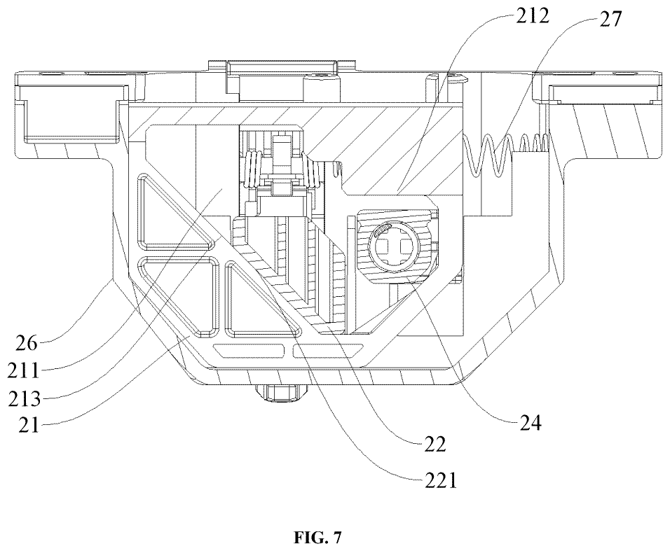

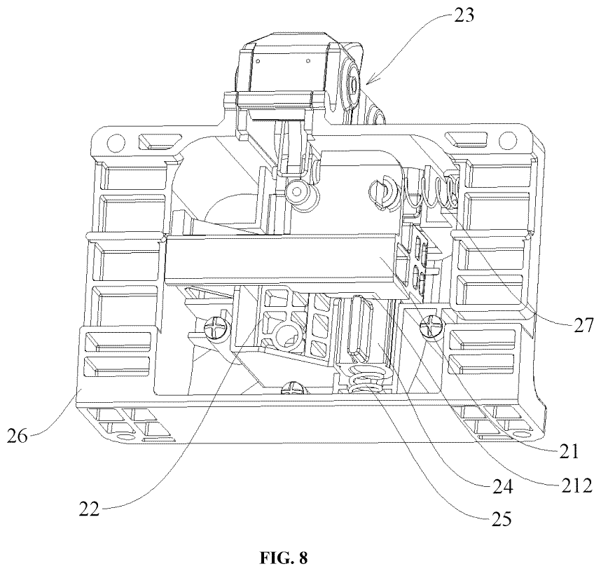

Please refer to FIGS. 1-8. The bearing device includes an openable box body 40 and a box lid 50. Here, the box body 40 serves as the main part of the bearing device, primarily responsible for storage tasks, expanding the vehicle's storage space, and facilitating the carrying of more luggage or items. The box lid 50 is tasked with sealing the box body 40, protecting the internal items from external environmental factors (such as wind, rain, and dust), while also providing security to prevent luggage from falling or being stolen during transit.

Based on the above structural foundation, the bearing device also includes a fixed locking element 10 and a movable locking element 20. One of the fixed locking element 10 and the movable locking element 20 is installed on the box body 40, and the other on the box lid 50. The movable locking element 20 can be locked into and engaged with the fixed locking element 10 to securely fasten the box lid 50 onto the box body 40 through their locking interaction.

It is worth mentioning that, taking a pair of cooperating fixed locking element 10 and movable locking element 20 as a lock unit for example, one or multiple sets of lock units can be arranged between the box body 40 and the box lid 50. An unlocking device 30 is then installed between the box body 40 and the box lid 50. During unlocking, activating the unlocking device 30 can release one or multiple sets of lock mechanisms.

Following the above embodiment, the movable locking element 20 is also provided with a movably engaged linkage component 21 and a driving component 22. The linkage component 21 is configured to reciprocate along a first direction, while the driving component 22 is configured to reciprocate along a second direction. It should be noted that the first and second directions can be rotational (e.g., clockwise or counterclockwise) or linear (e.g., horizontally forward or backward). When the linkage component 21 moves along the first direction, the driving component 22 moves along a direction different from the first direction (usually perpendicular or at an angle), enabling the movable locking element 20 to movably switch between a locked state (where it can engage with the fixed locking element 10) and the unlocking device (where it can release and disengage from the fixed locking element 10).

It should also be understood that in the practical application scenario of using the bearing device as a roof box, the linkage component 21 is generally located near the user operation end. That is, the movement of the linkage component 21 is typically triggered by user actions (such as rotating, pressing, or pulling). When the user wishes to lock the box lid 50 onto the box body 40 or unlock the box lid 50 from the box body 40, they can operate the linkage component 21 to move it along the first direction. The movement of the linkage component 21 drives the driving component 22 to move along the second direction, which further pushes or pulls other parts of the movable locking element 20 (such as latches or catches) to engage tightly with or disengage from the fixed locking element 10, thereby achieving the locking or unlocking of the box lid 50.

For ease of understanding, as an example, assume the linkage component 21 is a knob. When the user rotates the knob (the first direction being rotational, e.g., clockwise), the rotation of the knob is converted into linear motion of the driving component 22 (the second direction being vertical or horizontal) through internal mechanisms (such as cams, gears, or threads). The linear motion of the driving component 22 pushes or pulls other parts of the movable locking element 20, causing it to engage with or disengage from the fixed locking element 10, thereby achieving locking or unlocking.

Another possibility is that the linkage component 21 moves horizontally (the first direction being horizontal), while the driving component 22 moves vertically (the second direction being vertical). For instance, the linkage component 21 and the driving component 22 achieve directional conversion through components like the connecting rod 34 or sliders. This will not be further elaborated in this embodiment.

Based on the above embodiment, the bearing device further includes an unlocking device 30, which is used to provide corresponding operating positions for the user on the box body 40 or the box lid 50, enabling the user to perform corresponding operations on the movable locking element 20 through the unlocking device 30. Therefore, the position of the unlocking device 30 depends on the component where the movable locking element 20 is located. When the movable locking element 20 is installed on the box lid 50, the unlocking device 30 is also installed on the box lid 50, whereas when the movable locking element 20 is installed on the box body 40, the unlocking device 30 is installed on the box body 40 as well.

In practical application scenarios, the unlocking device 30 can receive unlocking signals from external sources, which may come from various input methods such as keys, buttons, or remote controls. Once the unlocking device 30 receives a valid unlocking signal, it immediately responds by triggering the unlocking action, allowing the user to further operate the movable locking element 20 through the unlocking device 30. Under normal conditions, the unlocking device 30 remains in a locked state, preventing the user from directly operating the movable locking element 20 through it. This enhances the closure stability and anti-theft performance of the box lid 50 and the box body 40, preventing accidental opening due to bumps or wind resistance during travel and ensuring driving safety. Additionally, the unlocking device 30 improves the anti-theft performance of the bearing device by incorporating more complex security mechanisms.

Specifically, the unlocking device 30 is equipped with a toggling block assembly 31 that can drive the movement of the movable locking element 20. The toggling block assembly 31 is a movable component within the unlocking device 30. As understood from the above, when the unlocking device 30 receives an unlocking signal, the toggling block assembly 31 is allowed to move under the user's operation, enabling it to switch the movable locking element 20 between the locked state and the unlocked state. Under normal usage conditions of the unlocking device 30, the toggling block assembly 31 is locked by the unlocking device 30 to prevent misoperation of the movable locking element 20.

In one embodiment, the unlocking device 30 is also provided with a first unlocking module 32 and a second unlocking module 33. As mentioned above, the first unlocking module 32 and/or the second unlocking module 33 are used to lock and release the toggling block assembly 31. The first unlocking module 32 and the second unlocking module 33 can be configured as two unlocking modules with identical structural functions or as two unlocking modules with different structural functions. For example, the first unlocking module 32 and the second unlocking module can be configured as a key unlocking module and an electronic unlocking module, respectively. The key unlocking module, as a traditional unlocking method, allows users to trigger the unlocking mechanism by inserting and rotating a physical key. When the key is inserted into the keyhole and rotated, it drives the mechanical components (such as cams or gears) inside the unlocking device 30 to move. These mechanical components then drive the locking parts (such as bolts or latches) to move, thereby releasing the toggling block assembly 31. The electronic unlocking module, as a modern unlocking method, allows users to trigger the unlocking mechanism through electronic signals (such as remote controls, mobile apps, fingerprint recognition, etc.). When the user sends an electronic unlocking signal, the receiver in the unlocking device 30 receives the signal and converts it into an electrical signal or mechanical motion. This electrical signal or mechanical motion drives the locking parts (such as electromagnets or motor-driven bolts) to move, thereby releasing the toggling block assembly 31.

In this embodiment, the key unlocking module and the electronic unlocking module are two independent unlocking methods, but both act on the same toggling block assembly 31. This means that regardless of which unlocking method the user chooses, as long as the unlocking is successful, the toggling block assembly 31 will be released.

The present disclosure adopts a combined locking mechanism of the first unlocking module 32 and the second unlocking module 33. Even if a single module is illegally breached, the other module can still prevent the unlocking action. In contrast, traditional single-module unlocking devices 30 allow direct opening of the box lid 50 once cracked. This solution fundamentally eliminates the risks of brute-force attacks or technical lock-picking, significantly enhancing the anti-theft performance of the bearing device.

Moreover, the design of the unlocking device 30 ensures that the toggling block assembly 31 is only released after a valid unlocking signal is received, preventing accidental opening of the box lid 50 due to misoperation or illegal actions. Additionally, through the coordinated design of the movable locking element 20 and the fixed locking element 10, the bidirectional motion constraints of the linkage component 21 and the driving component 22 can automatically compensate for deformation gaps in scenarios of vehicle bumps or vibrations, avoiding false unlocking caused by resonance and preventing accidental opening of the box lid 50. This significantly improves the safety of the bearing device under complex road conditions.

In the aforementioned embodiment featuring two unlocking methods, users can also choose the most convenient unlocking method based on their preferences and actual circumstances. Whether it is traditional key unlocking or modern electronic unlocking, both provide a fast and convenient unlocking experience.

Furthermore, the movable locking element 20 of this bearing device adopts a bidirectional motion-coupled structure of the linkage component 21 and the driving component 22, making it impossible for intruders to directly manipulate its unlocking by applying force in a single direction or using simple tools. For example, traditional lock cylinders only require rotation to unlock, whereas this solution first requires pushing the linkage component 21 in the first direction to release the lateral lock, followed by the driving component 22 completing the longitudinal unlocking in the second direction. The complexity of the motion trajectory increases the difficulty of illegal unlocking operations, effectively delaying the breach process. At the same time, in scenarios of vehicle bumps or vibrations, the bidirectional motion constraints of the linkage component 21 and the driving component 22 can automatically compensate for deformation gaps, avoiding false unlocking caused by resonance and effectively preventing accidental opening of the box lid 50. This enhances the safety of the bearing device under complex road conditions.

Please continue to refer to FIGS. 4-8 in the manual. As an optional implementation, the linkage component 21 in this implementation has a mounting hole 211 penetrating along the second direction. The linkage component 21 is located on the outer side of the mounting hole 211 and is drivingly connected to the toggling block assembly 31, enabling the driving component 22 to move along the predetermined direction (first direction) under the drive of the toggling block assembly 31.

The driving component 22 is movably arranged along the second direction within the mounting hole 211, allowing the linkage component 21 to move along the first direction under the drive of the toggling block assembly 31. The movable locking element 20 is also equipped with a latching hook assembly 23 at one end of the driving component 22. The latching hook assembly 23 switches between the locked state and the unlocked state based on the movement state of the driving component 22 along the second direction. Specifically, the mounting hole 211 in this movable locking element 20 primarily provides installation and movement space for the driving component 22 and related parts. The mounting hole 211 is arranged along the second direction, defining a clear movement path for the driving component 22. Guided by the mounting hole 211, the driving component 22 can perform linear motion along the predetermined direction, ensuring the accuracy and reliability of the unlocking device 30. It also ensures that the driving component 22 can be partially or fully embedded, maintaining stability during movement without deviation or detachment due to external forces.

At the same time, part of the mounting hole 211 serves as a guiding section for the driving component 22. In addition to ensuring linear motion along the predetermined direction (second direction), it also concentrates the torque generated during transmission toward the center of the driving component 22. This prevents additional torque caused by trajectory deviation during movement, improving the motion precision of the driving component 22. It also ensures more uniform force distribution on the driving component 22, avoiding additional stress and vibration due to eccentricity, further enhancing the mechanism's stability and reliability. This prevents unnecessary stress on the driving component 22 and linkage component 21, reducing wear and improving efficiency.

Moreover, the linkage component 21 is surrounded by the mounting hole 211, which also acts as a physical barrier for the linkage component 21 within the movable locking element 20. This effectively prevents friction between the linkage component 21 and other parts (such as the assembly housing 26), avoiding damage to precision components like the driving component 22 and extending the service life of the parts.

It should be understood that the latching hook assembly 23 is the component within the movable locking element 20 that directly engages in locking and unlocking operations. Its function is to achieve secure locking and convenient opening of the box lid 50 and box body 40 by engaging with or disengaging from the fixed locking element 10. When the driving component 22 is in its initial state, the latching hook assembly 23 remains in the locked state, allowing it to tightly engage with the fixed locking element 10. When a user triggers an unlock signal (such as pressing a remote control button or turning a key), the movable locking element 20 activates, and the linkage component 21 drives the driving component 22 to move along the second direction within the mounting hole 211. The movement of the driving component 22 is transmitted to the latching hook assembly 23, switching it from the locked state to the unlocked state, thereby enabling it to disengage from the fixed locking element 10.

Generally, the latching hook assembly 23 may include, but is not limited to, a rotatable or extendable hook-shaped structure with specific dimensions and shape designed to meet the engagement requirements with the fixed locking element 10. Additionally, the latching hook assembly 23 must be positioned at the end of the movable locking element 20 and securely connected to it, ensuring that the latching hook assembly 23 moves in sync with the motion of the movable locking element 20, thereby achieving locking and unlocking with the fixed locking element 10.

Please refer to FIGS. 4-10 in the manual. In one embodiment, the latching hook assembly 23 includes a hook base 231, a first latching hook 232, and a second latching hook 233. The hook base 231 is fixedly mounted on the movable locking element 20, serving as the foundational structure of the latching hook assembly 23. It provides a stable installation platform for the first latching hook 232 and the second latching hook 233, ensuring the overall structural stability of the latching hook assembly 23. The hook base 231 is also equipped with a hook groove 2311, which is configured to accommodate at least part of the fixed locking element 10. In other words, the shape and size of the hook groove 2311 match the portion of the fixed locking element 10 designed to engage with the movable locking element 20, ensuring that the fixed locking element 10 fits snugly into the hook groove 2311 in the locked state. The opposite ends of the first latching hook 232 are movably connected to the hook base 231 and the driving component 22 respectively, enabling the first latching hook (232) to move with the driving component 22 relative to the hook base 231. When the driving component 22 is subjected to an external force (e.g., a user turning a key or pressing a button), it moves along the second direction, driving the first latching hook 232 to move. The second latching hook 233 is rotatably mounted on the hook base 231 and is drivingly engaged with the first latching hook 232. The movement of the first latching hook 232 is transmitted to the second latching hook 233, causing it to rotate, thereby closing or opening the groove opening of the hook groove 2311. This enables the second latching hook 233 to securely lock the fixed locking element 10 within the hook groove 2311 or release it, allowing the fixed locking element 10 to disengage from the hook groove 2311.

In one embodiment, an elastic component (such as a torsion spring) is also arranged between the first latching hook 232 and/or the second latching hook 233 and the hook base 231. The elastic component continuously acts on the first latching hook 232 and/or the second latching hook 233, giving the second latching hook 233 a tendency to close the groove opening of the hook groove 2311. This ensures that after the fixed locking element 10 is placed into the hook groove 2311, the second latching hook 233 can stably lock it in place, maintaining the stability between the box lid 50 and the box body 40.

The latching hook assembly 23 adopts an integrated design, compactly combining the hook base 231, the first latching hook 232, and the second latching hook 233. This reduces the overall size of the lock, meeting the demands of confined spaces such as those in bearing devices (e.g., rooftop boxes).

At the same time, the first latching hook 232, as the driving component, is directly connected to the linkage component 21, efficiently transmitting external operational forces (such as those generated by a user turning a key or pressing a button) to the second latching hook 233. This enhances mechanical efficiency, making the locking or unlocking process faster and smoother. Through the coordinated operation of the first latching hook 232 and the second latching hook 233, force amplification or directional changes can also be achieved. This force conversion mechanism allows the lock to adapt more flexibly to various usage scenarios, improving its adaptability and reliability. When the second latching hook 233 is subjected to direct impact, the force acting on it can also be transmitted to the first latching hook 232 and other components like the lock base, thereby reducing the risk of direct damage to the latching hook assembly 23.

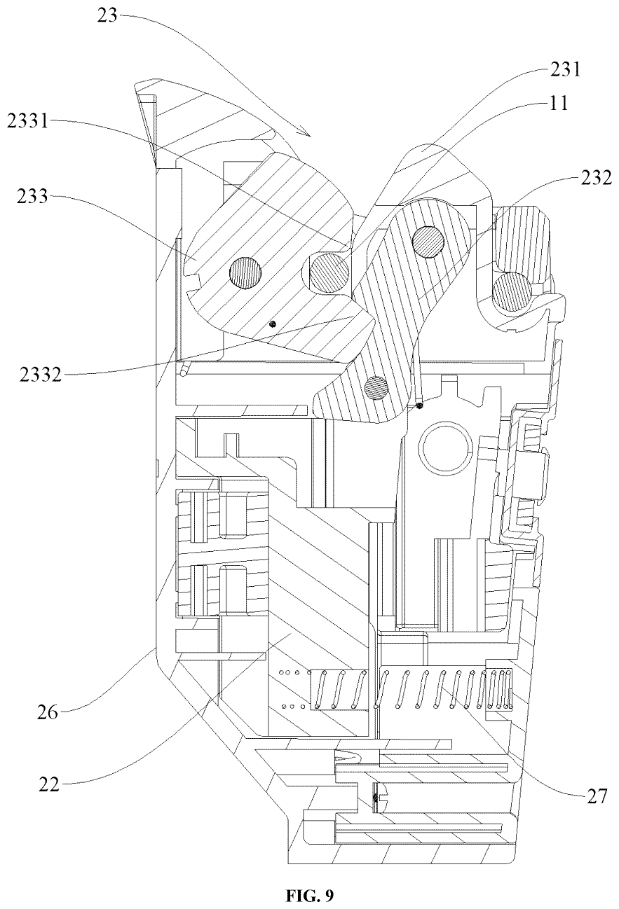

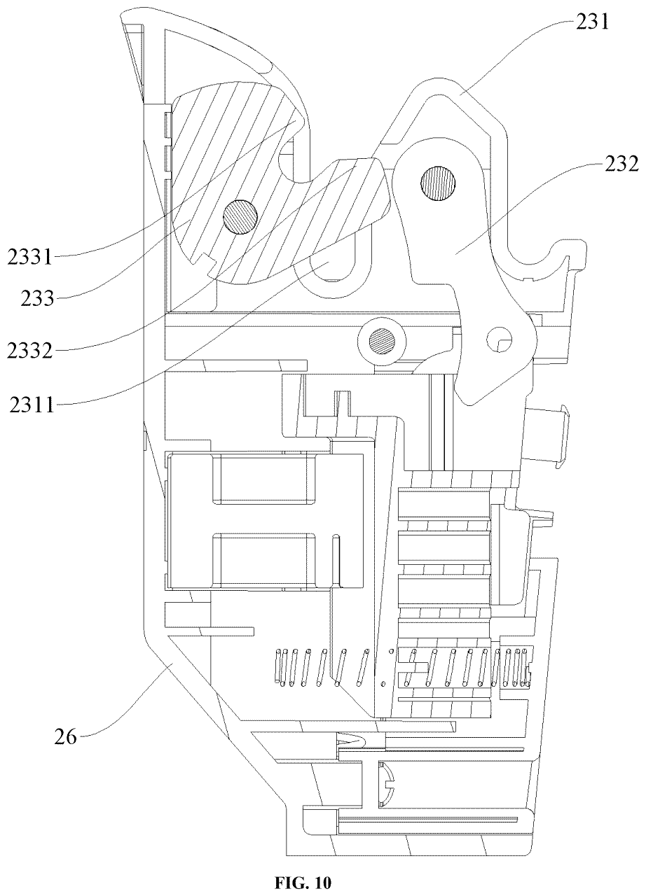

Please continue to refer to FIGS. 9-10 in the manual. As an optional implementation, to improve the reliability of the latching hook assembly 23 and provide it with the function of assisting the fixed locking element 10 in disengaging from the hook groove 2311, the second latching hook 233 in this implementation includes an engagement hook 2331 and a lift-off hook 2332. The engagement hook 2331 and the lift-off hook 2332 are located at opposite ends of the second latching hook 233, respectively serving to secure the fixed locking element 10 when the second latching hook 233 is in the state of closing the hook groove 2311, and assisting the fixed locking element 10 in disengaging from the hook groove 2311 when the second latching hook 233 opens the hook groove 2311.

Here, the engagement hook 2331 is positioned at the first end of the second latching hook 233. It can move between positions that close or open the groove opening of the hook groove 2311 through rotational or translational motion, preventing the fixed locking element 10 from disengaging from the hook groove 2311, or opening the groove opening of the hook groove 2311 in the unlocked state, allowing the fixed locking element 10 to move freely in and out.

The lift-off hook 2332 is positioned at the second end of the second latching hook 233. In specific application scenarios, the engagement hook 2331 is set closer to the groove opening of the hook groove 2311 compared to the lift-off hook 2332, while the lift-off hook 2332 is set closer to the base of the hook groove 2311 relative to the engagement hook 2331. Therefore, the lift-off hook 2332 can also be closer to the first latching hook 232, enabling it to form a sliding fit relationship with the first latching hook 232 more effectively. This allows the lift-off hook 2332 to extend into or retract from the base of the hook groove 2311 under the guidance of the first latching hook 232, thereby assisting in pushing the fixed locking element 10 out of the hook groove 2311.

Through the above configuration, especially in the embodiment where the latching hook assembly 23 is equipped with an elastic component, it effectively prevents the fixed locking element 10 from disengaging from the hook groove 2311, providing safety for the rooftop box. Additionally, when the engagement hook 2331 exits the hook groove 2311, the lift-off hook 2332 can extend from the bottom of the hook groove 2311, offering extra support to the fixed locking element 10, thereby assisting in opening the box lid 50 and enhancing user experience.

To further improve the safety performance of the bearing device, the movable locking element 20 also includes a fool-proofing component 24. At least part of the fool-proofing component 24 is movably arranged within the mounting hole 211, optimizing the installation space of the movable locking element 20 while providing certain protective performance for the fool-proofing component 24. In this embodiment, as shown in FIGS. 4-8, the fool-proofing component 24 is configured to move along a third direction, allowing its end to reciprocate between a position extending outside the movable locking element 20 and a position retracted inside it. In the embodiment where the movable locking element 20 is equipped with the latching hook assembly 23 and the hook base 231 of the latching hook assembly 23 has a hook groove 2311, the fool-proofing component 24 is positioned on one side of the hook base 231. When the fool-proofing component 24 extends outside the movable locking element 20, its end is located at a side of the hook groove 2311, enabling it to work alongside the lift-off hook 2332 to act on the fixed locking element 10 and assist in its disengagement from the hook groove 2311.

To enable the fool-proofing component 24 to perform the above functions, the movable locking element 20 is also equipped with a first elastic component 25 (such as a compression spring or tension spring). The first elastic component 25 continuously acts on the fool-proofing component 24, giving it a tendency to extend outside the movable locking element 20. This allows the fool-proofing component 24 to retract into the movable locking element 20 by overcoming the elastic force of the first elastic component 25 when pressed (e.g., when the fixed locking element is inserted into the hook groove 2311 and presses against the fool-proofing component 24). Conversely, when the fixed locking element 10 needs to disengage from the hook groove 2311, the first elastic component 25 can also assist by pushing the fool-proofing component 24 to extend outside the movable locking element 20, aiding the fixed locking element 10 in disengagement.

Please refer to FIGS. 9-10 in the manual. Taking the part of the fixed locking element 10 used to insert into the hook groove 2311 as the pressure rod 11 as an example, during the process of closing the box lid 50 and the box body 40, the pressure rod 11 can be inserted into the hook groove 2311 and pressed against the lift-off hook 2332, causing the second latching hook 233 to move. The lift-off hook 2332 exits the bottom of the hook groove 2311, allowing the engagement hook 2331 to enter the hook groove 2311 and lock the pressure rod 11. Simultaneously, the pressure rod 11 can also press against the fool-proofing component 24 on the side of the lock base, causing the fool-proofing component 24 to retract into the movable locking element 20. When the latching hook assembly 23 is operated by the user and the engagement hook 2331 exits the hook groove 2311, the lift-off hook 2332, together with the fool-proofing component 24, assists the pressure rod 11 in ejecting from the hook groove 2311, preventing the box lid 50 and the box body 40 from jamming, thereby improving the user experience.

In one embodiment, to prevent the fool-proofing component 24 from accidentally disengaging from the hook groove 2311 due to the action of the first elastic component 25 when the pressure rod 11 (fixed locking element) is locked in the movable locking element 20, as shown in FIGS. 4-8, the linkage component 21 is also equipped with a compressing part 212. When the movable locking element 20 is in the locked state, the compressing part 212 is offset from the fool-proofing component 24, allowing the fool-proofing component 24 to move along the third direction and extend out of the movable locking element 20 under the action of the first elastic component 25, assisting the fixed locking element 10 in disengaging. When the movable locking element 20 is in the unlocked state, the compressing part 212 presses against the fool-proofing component 24 to prevent it from extending out of the movable locking element 20. Thus, after the pressure rod 11 is inserted into the hook groove 2311 and locked by the latching hook assembly 23, the fool-proofing component 24 can also remain stably inside the movable locking element 20 under the action of the compressing part 212, avoiding the situation where the end of the fool-proofing component 24 continuously acts on the pressure rod 11, causing the pressure rod 11 to accidentally disengage from the hook groove 2311, thereby improving the locking stability of the fixed locking element 10 and the movable locking element 20.

It should be understood that during the entire unlocking process described above, the linkage component 21 will first contact the driving component 22, enabling the driving component 22 to drive the latching hook assembly 23 to unlock. Subsequently, the compressing part 212 disengages from restricting the fool-proofing component 24. This process follows a specific sequence, thereby reducing unnecessary issues caused by misoperation. At the same time, this sequence ensures the fool-proofing effect. Otherwise, if the fool-proofing component 24 resets before unlocking is achieved, the fool-proofing effect would be poor.

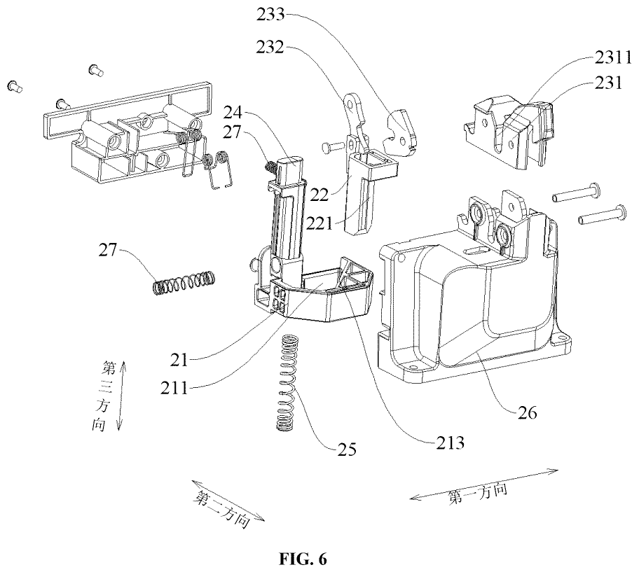

In one embodiment, referring to FIGS. 6-8 in the specification, the linkage component 21 is located within the mounting hole 211 and features a guiding inclined surface 213 that extends and slopes along the first direction. The outer surface of the driving component 22 is formed with a conforming inclined surface 221 that matches the guiding inclined surface 213. Accordingly, the driving component 22 slidably abuts the guiding inclined surface 213 through the conforming inclined surface 221, enabling the linkage component 21, when moving along the first direction, to push the driving component 22 to move along the second direction through the guiding inclined surface 213.

In the above implementation, the arrangement of the guiding inclined surface 213 and the conforming inclined surface 221 allows the linear motion of the linkage component 21 along the first direction to be converted into the linear motion of the driving component 22 along the second direction, eliminating the need for additional steering mechanisms (such as gear sets or levers). This significantly reduces the number of parts, making the overall structure more compact—particularly suitable for space-constrained scenarios like rooftop cargo boxes. Moreover, the setup of the guiding inclined surface 213 and the conforming inclined surface 221 directly utilizes the structures within the mounting hole 211 and on the surface of the driving component 22 for engagement, avoiding external protrusions or complex transmission mechanisms. This optimizes the space occupancy of the movable locking element 20, maximizing the internal loading capacity of the bearing device.

Additionally, the inclined surface interaction between the linkage component 21 and the driving component 22 provides a larger contact area, distributing their mutual forces more evenly compared to point or line contact transmissions (such as cam mechanisms). This results in reduced wear, extended lifespan, and effectively enhances the durability of the bearing device.

Exemplarily, this embodiment takes the first direction as the X-axis direction on the horizontal plane, the second direction as the Y-axis direction on the horizontal plane, and the third direction as the Z-axis direction as an example. During the reciprocating motion of the linkage component 21 along the first direction, the position of the guiding inclined surface 213 acting on the conforming inclined surface 221 of the driving component 22 in the second direction changes, thereby enabling the driving component 22 to vary in height position along the horizontal Y-axis direction as the linkage component 21 moves along the horizontal X-axis direction. Further, both the first latching hook 232 and the second latching hook 233 adopt a rotational driving method. In this embodiment, to convert the vertical motion of the driving component 22 into the rotational motion of the first latching hook 232, an oblong hole 222 extending along the Z-axis direction is provided at the connection between the driving component 22 and the first latching hook 232. Consequently, during the heightwise horizontal movement of the driving component 22, it can drive the first latching hook 232 to rotate slightly without causing interference or jamming. During the unlocking process of the movable locking element 20, the linkage component 21 moves horizontally, causing the driving component 22 to rise through the interaction between the guiding inclined surface 213 and the conforming inclined surface 221. The driving component 22 then pushes the first latching hook 232 to reverse through the oblong hole 222, thereby enabling the first latching hook 232 to drive the second latching hook 233 through sliding transmission until the engagement hook 2331 exits the hook groove 2311, and the lift-off hook 2332 extends into the hook groove 2311 from its base. To allow the movable locking element 20 to reset from the unlocked state to the locked state after external force is removed, a second elastic component 27 can be installed on the driving component 22 and/or the linkage component 21. This ensures that the driving component 22 and linkage component 21 (as well as the elastic component on the latching hook assembly 23) can reset. During the reset process, the elastic component and the driving component 22 drive the first latching hook 232 to rotate forward, enabling the second latching hook 233 to rotate until the engagement hook 2331 enters the hook groove 2311 and the lift-off hook 2332 exits from the base of the hook groove 2311.

It is worth noting that when there is no pressure rod 11 (fixed locking element 10) pressed into the hook groove 2311, the fool-proofing component 24 will remain extended from the movable locking element 20 under the action of the first elastic component 25. This obstructs the movement of the linkage component 21. Therefore, the linkage component 21, driving component 22 and latching hook assembly 23 will only reset when the fool-proofing component 24 is pressed into the movable locking element 20 by the pressure rod 11, allowing the compressing part 212 of the linkage component 21 to be offset from the fool-proofing component 24. enabling the movable locking assembly to return from the unlocked state to the locked state, completing the locking between the movable locking element 20 and the fixed locking element 10, thereby achieving true fool-proofing.

Please refer to FIG. 4 in the manual. In one embodiment, the movable locking element 20 further includes an assembly housing 26, which serves as the supporting base for the movable locking element 20. Its interior forms a hollow mounting cavity, where the linkage component 21 and driving component 22 are both movably installed. Additionally, in implementations where the movable locking element 20 also includes the latching hook assembly 23 and fool-proofing component 24, the hook base 231 of the latching hook assembly 23 and the fool-proofing component 24 can also be installed on the assembly housing 26, preventing external dust and moisture from entering and significantly improving the reliability of the movable locking element 20 in harsh environments (such as rain, snow, or dust).

The aforementioned second elastic component 27 is also installed within the mounting cavity and acts on the linkage component 21 and/or driving component 22, ensuring the movable locking element 20 tends to move toward the locked state. This allows the latching hook assembly 23 to reset effectively after the fool-proofing component 24 is pressed into the assembly housing 26.

Please refer to FIGS. 1-3 in the manual. The unlocking device 30 also includes a connecting rod 34, which is provided with a dead stroke section 341. The connecting rod 34 is connected to the toggling block assembly 31 or the linkage component 21 through the dead stroke section 341. When the dead stroke section 341 is connected to the toggling block assembly 31, its extension direction is determined by the operating direction of the toggling block assembly 31. Conversely, when the dead stroke section 341 is connected to the linkage component 21, it aligns with the movement direction of the linkage component 21, i.e., extending along the first direction. The opposite ends of the dead stroke section 341 can interact with either the toggling block assembly 31 or the linkage component 21. This ensures that the toggling block assembly 31 must be operated a certain distance from its initial position toward unlocking the movable locking element 20 before the dead stroke section 341 engages with the toggling block assembly 31, thereby driving the movement of the linkage component 21. Alternatively, the dead stroke section 341 only engages with the linkage component 21 after the toggling block assembly 31 has been operated a certain distance from its initial position toward unlocking the movable locking element 20, enabling subsequent linkage operations.

From the unlocking process described in the above embodiment, it can be understood that during the movement of the toggling block assembly 31 from its initial position toward unlocking the movable locking element 20, the presence of the connecting rod 34 causes a dead stroke between the toggling block assembly 31 and the linkage component 21 before formal unlocking begins. The dead stroke section 341 forms an “ineffective stroke” in the movement path of the connecting rod 34. When a user accidentally touches the unlock button or the lock experiences slight vibrations, the connecting rod 34 may displace, but the dead stroke section 341 ensures this displacement is not directly transmitted to the toggling block assembly 31 or the linkage component 21, thereby preventing accidental unlocking. This also extends the time required for malicious unlocking attempts, such as by thieves, enhancing security. For example, in outdoor or poorly lit locations, the safety of unlocking a rooftop box is relatively higher due to the design described in this embodiment.

In one embodiment, when multiple movable locking mechanisms are present, the unlocking device 30 can connect multiple movable locking elements 20 through the connecting rod 34. The dead stroke section 341 on the connecting rod 34 may be positioned between the connecting rod 34 and at least one movable locking element 20. Thus, during the movement of the dead stroke section 341, the latching hook assembly 23 of some movable locking elements 20 has already completed locking, achieving a single-point locking effect.

Compared to the locking control in the prior art, the prominent feature of this embodiment is that when two or more movable locking elements 20 and the fixed locking element 10 achieve locking, at least one movable locking element 20 is in the locked state, while the other movable locking elements 20 and the fixed locking element 10 can achieve more precise positioning. By applying external force to the movable locking elements 20 still in the unlocked state, it becomes easier to fully lock them with the fixed locking element 10 and the movable locking elements 20, enhancing the user's operational experience during the locking process.

Referring to the accompanying drawings, as an optional implementation, the toggling block assembly 31 includes a toggling component, which is connected to the first unlocking module 32 and the second unlocking module 33. To facilitate the transmission between the toggling component and the linkage component 21, a stable and reliable connection is required between them. The toggling component includes a toggling body and a first toggling rod (not shown) and a second toggling rod (not shown) arranged on one side of the toggling body. The first and second toggling rods are drivingly engaged with the linkage component 21.

It is understandable that in the implementation where the unlocking device 30 is further provided with a connecting rod 34, the first and second toggling rods are engaged with the connecting rod 34. Accordingly, the connecting rod 34 is also provided with connection structures that match the first and second toggling rods.

In one embodiment, the first and second toggling rods are arranged along the direction in which the connecting rod 34 extends, further improving the force stability between the toggling component and the connecting rod 34.

To facilitate the toggling of the toggling body, a toggling grip exposed outside the unlocking device 30 is also provided on the second side of the toggling body.

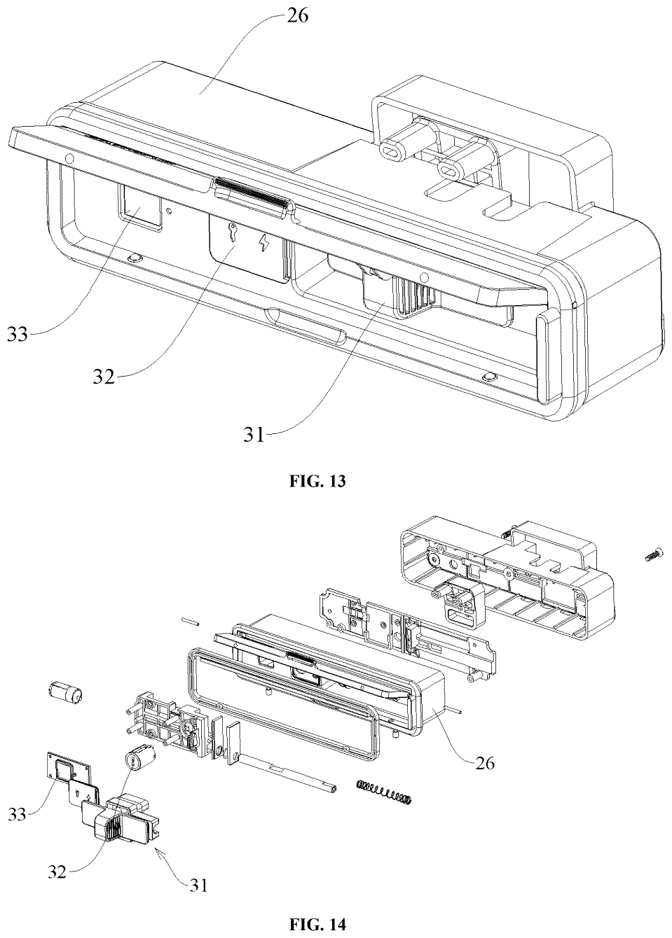

Further, referring to FIGS. 1-3 and 11-14 in the accompanying drawings, the fixed locking element 10 and the movable locking element 20 in the embodiment of the present disclosure are each provided in three. The three movable locking elements 20 are arranged along the length direction of the connecting rod 34, located at both ends and the middle of the connecting rod 34. In this embodiment, all three movable locking elements 20 can move with the action of the connecting rod 34, allowing the user to synchronously unlock all three movable locking elements 20 when operating the toggling component.

To facilitate the installation of the unlocking device 30 on the box lid 50 or the box body 40, the unlocking device 30 further includes a mounting case 35. The toggling block assembly 31, the first unlocking module 32, and the second unlocking module 33 are all arranged in the mounting case 35, while the toggling grip on the toggling component and the parts of the first and second unlocking modules 32 and 33 for user operation are exposed outside the mounting case 35.

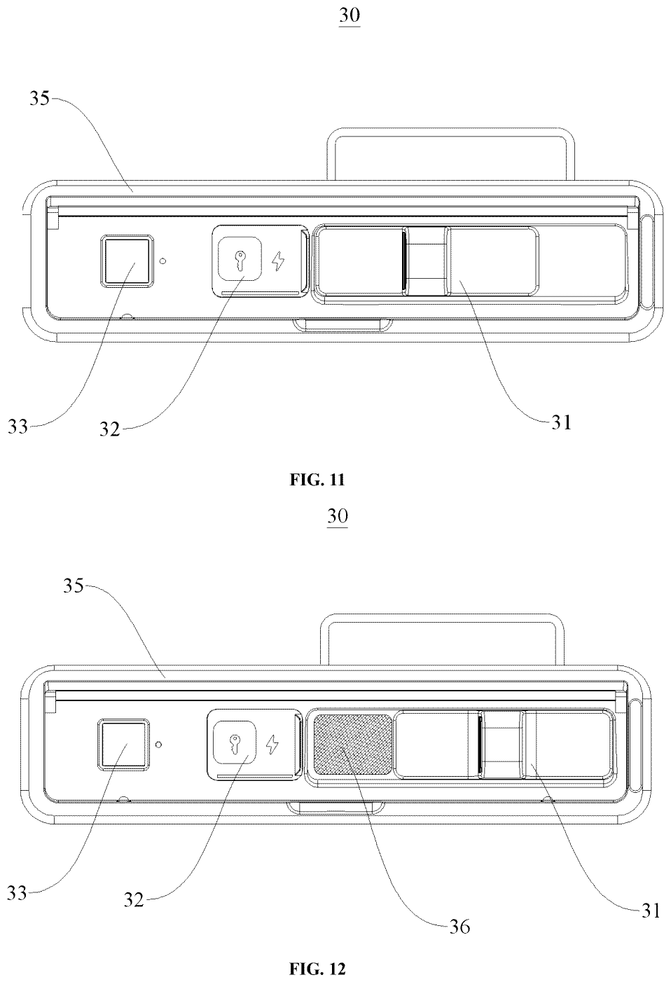

Referring to FIGS. 11-14, to facilitate reminding users of false locking or incomplete locking, this embodiment also includes a warning strip 36 located inside the mounting case 35. The warning strip 36 is positioned on the side of the toggling component close to the interior of the mounting case 35 and only on one side of the toggling component's movement path. During the locking process of the movable locking element 20, if the movable locking element 20 is in a false-locked state (where components have not reset to positions conforming to the locked state), the connecting rod 34 will restrain the toggling component, keeping it in an unreset state. This exposes the warning strip 36, thereby promptly alerting the user that the locking is incomplete and requires rechecking and relocking.

In other embodiments (not shown), the bearing device is a side-opening trunk expansion box. Its core structure still includes an openable box body 40 (horizontally placed with the opening facing the vehicle side) and a box lid 50 (side-flip opening). The difference lies in the layout and operation of the locking unit adapted for side-opening scenarios: two sets of locking units, each composed of a fixed locking element 10 and a movable locking element 20, are symmetrically arranged on the upper and lower edges of the box body 40 (compared to the original top/middle placement). The fixed locking element 10 is fixed to the side edge of the box body 40, while the movable locking element 20 is correspondingly placed on the inner side of the box lid 50 (consistent with the original logic of “one on the box body, one on the box lid”). The unlocking device 30 is integrated into the grip handle on the outer side of the box lid 50 (originally on the top/side), and its toggling block assembly 31 is designed as a “press-type toggling component”—users can simultaneously press and toggle the toggling block assembly 31 while gripping the handle, aligning the operation path with side-opening habits. The connecting rod 34 extends along the height direction of the box lid 50 (originally horizontally), with the dead stroke section 341 positioned near the lower locking unit. When the user initially toggles the toggling block assembly 31, the connecting rod 34 first unlocks the upper movable locking element 20 (the dead stroke section 341 is not in linkage with the lower unit). Continued toggling then triggers the unlocking of the lower movable locking element 20 through the dead stroke section 341, preventing tilting or jamming of the box lid 50 due to unilateral force. The inner wall of the hook groove 2311 in the latching hook assembly 23 is additionally fitted with a wear-resistant rubber pad (absent in the original), and the surface of the pressure rod 11 in the fixed locking element 10 is textured for roughness. During vehicle turns or tilts, the rubber pad and rough texture increase friction, preventing slight sliding of the pressure rod 11 within the hook groove 2311, further enhancing locking stability.

In other embodiments (not shown), based on the original “key+electronic” dual unlocking module, a biometric unlocking module (the third unlocking module) is added to form a triple unlocking mechanism, catering to the intelligent interaction needs of high-end models: the third unlocking module is a fingerprint recognition module, integrated on the surface of the mounting case 35 of the unlocking device 30 (exposed externally, arranged side by side with the keyhole and electronic button). It internally includes a fingerprint sensor and a control chip, which can interact with the vehicle's central control system (or operate independently). Unlocking logic: the third unlocking module and the first and second unlocking modules (key and electronic) are in an “OR” relationship—the user can trigger the unlocking device 30 to release the toggling block assembly 31 through any one of three methods: fingerprint verification (touching the sensor for 1-2 seconds), key rotation, or remote control button press. If the “dual verification” mode needs to be activated (e.g., for long-distance transport of valuable items), it can be set to “fingerprint+key” or “fingerprint+electronic” combined verification through the toggle switch inside the mounting case 35. In this case, both unlocking signals must be valid simultaneously to release the toggling block assembly 31. The fool-proofing component 24 is equipped with a micro-switch sensor: when the fool-proofing component 24 is pressed into the movable locking element 20 by the pressure rod 11, the micro-switch sensor triggers and sends a “locking ready” signal back to the third unlocking module. If the fool-proofing component 24 is not fully pressed in (false lock state), the sensor will disable the fingerprint unlocking function (retaining only key unlocking) and alert the user through a flashing red indicator on the surface of the mounting case 35, creating a dual safeguard of “mechanical fool-proofing+electronic warning.” In other embodiments (not shown), the transmission structure and elastic component of the movable locking element 20 are optimized: The inclined surface cooperation between the linkage component 21 and the driving component 22 (guiding inclined surface 213, conforming inclined surface 221) is spray-coated with a wear-resistant polytetrafluoroethylene (PTFE) layer, with a thickness of 0.1-0.2 mm, which reduces friction loss between the inclined surfaces during bumps and minimizes the risk of “inclined surface slippage” caused by vibrations. Additionally, the inclination angle of the guiding inclined surface 213 is adjusted from 30° in the original example to 45°, improving transmission efficiency and preventing motion stuttering of the driving component 22 due to vibrations. The elastic component of the latching hook assembly 23 is replaced with a disc spring (originally a torsion spring): The disc spring is installed at the connection between the second latching hook 233 and the hook base 231. Its fatigue resistance is 3-5 times that of a torsion spring, and its elasticity can be adjusted by stacking combinations—when vehicle bumps cause a transient gap between the pressure rod 11 and the hook groove 2311, the instantaneous elasticity of the disc spring can quickly push the second latching hook 233 to press against the pressure rod 11, compensating for the gap and preventing resonance-induced unintended unlocking. The assembly housing 26 is made of metal (originally plastic), and rubber cushioning pads are added to the inner walls of the mounting cavity: These pads wrap around the non-transmission areas of the linkage component 21 and the driving component 22, absorbing over 80% of lateral vibrations (such as side-to-side shaking during off-road driving) and preventing unintended first-direction movement of the linkage component 21 due to vibrations. Meanwhile, drainage holes are added at the bottom of the assembly housing 26 to prevent internal water accumulation and component rusting during rain or snow. The connecting rod 34 is made of carbon fiber (originally metal), reducing its weight by 40% while doubling its bending resistance. A universal joint is added at the connection between the connecting rod 34 and the toggling block assembly 31, allowing it to accommodate minor angular offsets of the bearing device caused by frame deformation during off-road driving, thereby avoiding breakage due to excessive rigidity.

In other embodiments (not shown), a quick-release fixing mechanism 60 is added to the original structure, while optimizing the operational convenience of the unlocking device: the quick-release fixing mechanism includes two sets of “U-shaped claws” installed at the bottom of the box body 40, an “adjustable screw” compatible with roof racks of different widths, and a “rotating latch” for locking the claws. Users do not require tools; they simply need to clamp the U-shaped claws onto the roof rack crossbar, rotate the adjustable screw until the crossbar is tightly secured, and then twist the rotating latch to complete the fixation of the box body 40. For removal, the process is reversed, taking no more than 1 minute (the original example required screwdriver assistance and took 3-5 minutes). The toggling block assembly 31 of the unlocking device 30 is designed as a bidirectional toggling structure: users can toggle the toggling block assembly 31 from either the left or right side of the bearing device (the original example allowed only unilateral operation), accommodating the roof operation space of different vehicle models (e.g., some models have roof rack crossbars obstructing the left side, allowing operation from the right). Additionally, the surface of the toggling grip 311 is enhanced with anti-slip textures, and its height is increased by 5 mm, facilitating operation while wearing gloves (such as in winter scenarios). The end of the pressure rod 11 of the fixed locking element 10 is equipped with a guiding slope 111: when the box lid 50 is closed, the guiding slope 111 directs the pressure rod 11 to automatically slide into the hook groove 2311, eliminating the need for manual alignment. Furthermore, the pressure rod 11 is made of an elastic material (e.g., polyurethane), allowing slight deformation if minor misalignment occurs during closure, preventing damage from rigid collisions with the latching hook assembly 23.

In other embodiments (not shown), the material and structure of the unlocking device and the movable locking element 20 are adapted: the lock cylinder of the first unlocking module 32 (key module) of the unlocking device 30 is made of copper-nickel alloy (originally brass), with a high-low temperature resistance range of −40° C.-120° C., preventing the lock cylinder from freezing at low temperatures (making key insertion impossible) or expanding at high temperatures (causing key rotation to jam). Additionally, a silicone dust cover 321 is added to the inner side of the keyhole, connected to the keyhole edge through a spring, automatically closing when no key is inserted to prevent dust or ice from entering the lock cylinder. The driving component 22 of the movable locking element 20 is made of nylon 66 + glass fiber-reinforced material (originally standard nylon), with its heat deflection temperature increased to 250° C. and low-temperature impact strength improved by 30%, avoiding softening of the driving component 22 at high temperatures (preventing it from pushing the latching hook assembly 23) or brittleness at low temperatures (leading to vibration-induced fractures). Furthermore, the inner wall of the oblong hole 222 in the driving component 22 is lined with a metal bushing 223 to reduce friction resistance between the driving component 22 and the first latching hook 232 at low temperatures. The first elastic component 25 of the fool-proofing component 24 is replaced with a silicone rubber spring 251 (originally a coil spring): the silicone rubber spring 251 exhibits a spring force variation rate of less than 5% (compared to 15%-20% for metal springs) within the range of −50° C. to 200° C., ensuring stable extension/retraction of the fool-proofing component 24 under extreme temperatures. Additionally, the end of the fool-proofing component 24 is wrapped with a low-temperature weather-resistant rubber sleeve 242 to prevent brittleness caused by collisions with the pressure rod 11 at low temperatures. An insulation layer 351 is added to the exterior of the mounting case 35: the insulation layer 351 is made of aerogel material, 3-5 mm thick, blocking over 85% of external heat or cold from transferring to the internal toggling block assembly 31 and unlocking module, ensuring that the operational feel of the unlocking device 30 remains consistent with that at room temperature under −40° C.-80° C. conditions.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A bearing device, comprising a box body and a box lid that are openable and closable, and further comprising:
a fixed locking element; and
a movable locking element, capable of locking into and engaging with the fixed locking element, wherein one of the movable locking element and the fixed locking element is installed on the box body and the other on the box lid, and the movable locking element is movably switchable between a locked state and an unlocked state; and
an unlocking device installed on the box body or the box lid, wherein the unlocking device is equipped with a toggling block assembly that drives the movable locking element to move, and at least one unlocking module for releasing the toggling block assembly.

2. The bearing device according to claim 1, wherein the unlocking module is configured as either an electronic unlocking module or a key unlocking module.

3. The bearing device according to claim 1, wherein the movable locking element is equipped with a linkage component and a driving component that can be movably engaged, and when the linkage component moves along a first direction, the driving component moves along a second direction, enabling the movable locking element to movably switch between the locked state and the unlocked state.

4. The bearing device according to claim 3, wherein a mounting hole penetrates through the linkage component along the second direction, with the linkage component located outside the mounting hole and drivingly connected to the toggling block assembly; and
the driving component is movably installed within the mounting hole, and one end of the movable locking element where the driving component is located is equipped with a latching hook assembly that switches between the locked state and the unlocked state based on a movement of the driving component along the second direction.

5. The bearing device according to claim 4, wherein the latching hook assembly comprises:
a hook base fixedly arranged on the movable locking element, wherein the hook base has a hook groove configured to provide space for accommodating at least part of the fixed locking element;
a first latching hook, with two opposite ends movably connected to the hook base and the driving component respectively, allowing the first latching hook to move relative to the hook base along with the driving component; and
a second latching hook rotatably installed on the hook base and drivingly engaged with the first latching hook, enabling the second latching hook to close or open a groove opening of the hook groove as the first latching hook moves.

6. The bearing device according to claim 5, wherein the second latching hook comprises:
an engagement hook located at a first end of the second latching hook, wherein the engagement hook is movable between positions that close or open the groove opening of the hook groove; and
a lift-off hook arranged at a second end of the second latching hook, wherein the lift-off hook is slidably engaged with the first latching hook and can extend into or retract from a bottom of the hook groove.

7. The bearing device according to claim 4, wherein the movable locking element further comprises:
a fool-proofing component, at least partially movably arranged within the mounting hole, wherein the fool-proofing component is configured to move along a third direction, allowing an end of the fool-proofing component to reciprocate between a position protruding outside the movable locking element and a position retracted into the movable locking element; and
a first elastic component acting on the fool-proofing component to bias the fool-proofing component toward protruding from the movable locking element;
wherein the linkage component is further provided with a compressing part, the compressing part is offset from the fool-proofing component when the movable locking element is in the locked state, allowing the fool-proofing component to move along the third direction, and presses against the fool-proofing component when the movable locking element is in the unlocked state, preventing the fool-proofing component from protruding from the movable locking element.

8. The bearing device according to claim 4, wherein the linkage component forms a guiding inclined surface within the mounting hole, extending and inclining along the first direction, and an outer surface of the driving component forms a conforming inclined surface matching the guiding inclined surface; and
the driving component slidably presses against the guiding inclined surface through the conforming inclined surface, so that when the linkage component moves along the first direction, the driving component is pushed to move along the second direction through the guiding inclined surface.

9. The bearing device according to claim 3, further comprising:
an assembly housing, with a hollow mounting cavity formed therein, wherein the linkage component and the driving component are movably arranged within the mounting cavity; and
a second elastic component arranged within the mounting cavity and acting on the linkage component and/or the driving component, biasing the movable locking element toward the locked state.

10. The bearing device according to claim 3, wherein the unlocking device further comprises:
a connecting rod provided with a dead stroke section, wherein the connecting rod is connected to the toggling block assembly or the linkage component through the dead stroke section, with opposite ends of the dead stroke section linked with the toggling block assembly or the linkage component.

11. A bearing device, comprising:
a box body and a box lid that are openable and closable; and
a fixed locking element and a movable locking element, wherein one of the fixed locking element and the movable locking element is arranged on the box body and the other on the box lid, with the movable locking element capable of locking into and engaging with the fixed locking element;
wherein the movable locking element comprises a linkage component and a driving component that are movably engaged, the linkage component is configured to reciprocate along a first direction, and the driving component is configured to reciprocate along a second direction, such that when the linkage component moves along the first direction, the driving component moves along a direction different from the first direction, enabling the movable locking element to switch between a locked state and an unlocked state; and
an unlocking device configured to provide an operating position for a user on the box body or the box lid, wherein the unlocking device comprises a toggling block assembly capable of driving the movable locking element to move, a first unlocking module, and a second unlocking module, and the first unlocking module and/or the second unlocking module is configured to lock and release the toggling block assembly.

12. The bearing device according to claim 11, wherein a mounting hole penetrates through the linkage component along the second direction, the linkage component is located outside the mounting hole and is drivingly connected to the toggling block assembly, and the driving component is movably arranged within the mounting hole along the second direction.

13. The bearing device according to claim 12, wherein one end of the movable locking element where the driving component is located is equipped with a latching hook assembly that switches between the locked state and the unlocked state as the driving component moves along the second direction.

14. The bearing device according to claim 13, wherein the latching hook assembly comprises a hook base, a first latching hook and a second latching hook;
the hook base is fixed to the movable locking element and has a hook groove for accommodating at least part of the fixed locking element;
both ends of the first latching hook are movably connected to the hook base and the driving component respectively; and
the second latching hook is rotatably arranged on the hook base and drivingly engaged with the first latching hook to close or open a groove opening of the hook groove.

15. The bearing device according to claim 14, wherein the second latching hook is respectively provided with an engagement hook and a lift-off hook at two ends; and
the engagement hook is movable to close or open the groove opening of the hook groove; and
the lift-off hook is capable of extending into or retracting from a bottom of the hook groove under the drive of the first latching hook.

16. The bearing device according to claim 15, wherein the movable locking element further comprises a fool-proofing component, and at least part of the fool-proofing component is movably arranged within the mounting hole and is movable along the third direction to extend or retract an end thereof from the movable locking element; and
the movable locking element is further provided with a first elastic component that continuously acts on the fool-proofing component to bias the fool-proofing component to extend out.

17. The bearing device according to claim 16, wherein the linkage component is further provided with a compressing part, and when the movable locking element is in the locked state, the compressing part is offset from the fool-proofing component; and
when in the unlocked state, the compressing part presses against the fool-proofing component to prevent the fool-proofing component from extending out.

18. The bearing device according to claim 16, wherein the linkage component forms a guiding inclined surface that is inclined and extends along the first direction within the mounting hole;
an outer surface of the driving component forms a conforming inclined surface matching the guiding inclined surface; and
the driving component is slidably engaged with the guiding inclined surface through the conforming inclined surface, allowing the linkage component to push the driving component to move along the second direction when moving along the first direction.

19. The bearing device according to claim 11, wherein the unlocking device further comprises a connecting rod provided with a dead stroke section, and the connecting rod is connected to the toggling block assembly or the linkage component through the dead stroke section; and
the linkage component is driven to move by the dead stroke section only after the toggling block assembly has been operated over a certain distance.

20. The bearing device according to claim 19, wherein the toggling block assembly comprises a toggling component, and one side of the toggling component is provided with a first toggling rod and a second toggling rod that are both drivingly engaged with the linkage component; and
both the fixed locking element and the movable locking element are provided in three, distributed along a length direction of the connecting rod at two ends and a middle portion thereof.
